(19) United States
(12) Patent Application Publication
(10) Pub. No.: US 2017/0313205 A1
(43) Pub. Date: Nov. 2, 2017

(54) BATTERY CHARGING METHOD AND SYSTEM OF BATTERY ELECTRIC VEHICLE

(71) Applicant: PRIMAX ELECTRONICS LTD., Taipei (TW)

(72) Inventors: Ying-Che Tseng, Taipei (TW); Cheng-Yi Tsai, Taipei (TW)

(21) Appl. No.: 15/215,201

(22) Filed: Jul. 20, 2016

(30) Foreign Application Priority Data
Apr. 29, 2016 (TW) 105113488

(51) Int. Cl. B60L 11/18; H02J 7/00

(52) U.S. Cl. CPC B60L 11/1846; B60L 11/1848; H02J 7/0021; B60L 11/1816; B60L 2230/16; H02J 2007/0001; B60L 2270/32

(57) ABSTRACT

A charging method of a battery electric vehicle is provided. In the method of the present invention, a user of a battery electric vehicle sends a pairing request to a charging station by using a mobile phone. The charging station sends a charging authentication code to the mobile phone after pairing succeeds. During charging, the charging station keeps monitoring whether a charging connector of the charging station is separated from a charging interface of the battery electric vehicle. When monitoring that the charging connector is separated from the charging interface of the battery electric vehicle, the charging station stops charging, and sends a charging confirmation request to the mobile phone. When receiving the charging authentication code again, the charging station continues charging the battery electric vehicle. A charging system using the method is further provided. With the present invention, an electricity stealing behavior of another person during a charging process may be prevented.

### FIELD OF THE INVENTION

The present invention relates to a charging method and system, and more particularly to a charging method and system of a battery electric vehicle.

### BACKGROUND OF THE INVENTION

Battery electric vehicle includes battery electric locomotive and battery electric automobile. Using a battery as a power source has an advantage of avoiding air pollution caused by fuel. Therefore, recently, more and more users choose a battery electric vehicle instead of a gasoline-powered vehicle.

A main power source of a battery electric vehicle is provided by a battery in the vehicle. Therefore, charging stations for charging battery electric vehicles need to be universally arranged, so as to make it convenient for a user to charge a battery electric vehicle. Each charging station has a charging cable, and one end of the cable is a charging connector. A charging connector is connected to a charging interface of a battery electric vehicle, so as to enable a charging station to charge the battery electric vehicle.

There are several payment modes for charging. For one mode, a user prepays a fixed amount of money to a charging station, and charging is stopped when the costs of a charged quantity of electricity reaches the prepaid amount of money. Alternatively, after charging is completed, a payment is made by swiping a credit card, or the charging station generates a payment bill and the payment is made to a fee collection station.

According to a quantity of electricity that is needed, a charging station may need ten to tens of minutes to complete the charging. During duration of waiting for the completing of the charging, sometimes, a user may leave the charging station. Generally, most charging stations only have charging devices and are not equipped with management personnel. Therefore, when the user is away from the charging station, another person may move, to another battery electric vehicle for charging, a charging connector connected to a battery electric vehicle being charged. That is, a situation of stealing electricity may occur during a charging process. Therefore, a new charging method and system are needed for preventing the situation of stealing electricity.

### SUMMARY OF THE INVENTION

A main objective of the present invention is to provide a charging method and system of a battery electric vehicle for preventing a situation of stealing electricity.

The present invention provides a charging method of a battery electric vehicle, which is applied to charging, by using a charging station, a battery electric vehicle, where the charging station is connected to a charging interface of the battery electric vehicle by using a charging connector and transfers power to the battery electric vehicle. The method includes steps of: (a) transmitting, by a handheld electronic device, a pairing request signal to the charging station; (b) randomly generating, after the charging station receives the pairing request signal and confirms that pairing succeeds, a charging authentication code, and transmitting the charging authentication code to the handheld electronic device; (c) transmitting, by the handheld electronic device, the charging authentication code to the charging station; (d) starting to charge the battery electric vehicle when the charging station receives the charging authentication code and confirms that the charging connector is connected to the charging interface, where during duration that the battery electric vehicle is charged, the charging station keeps monitoring whether the charging connector is separated from the charging interface, stops charging the battery electric vehicle when monitoring that the charging connector is separated from the charging interface, and transmits a charging confirmation request to the handheld electronic device; and (e) requiring, by the charging station, the handheld electronic device to provide the charging authentication code when the handheld electronic device transmits a charging continuation instruction to the charging station, and continuing charging the battery electric vehicle after receiving the charging authentication code.

The present invention further provides a charging system of a battery electric vehicle, including: a charging station, and a handheld electronic device having a second monitoring program. The charging station is configured to provide power to a battery electric vehicle. The charging station includes: a charging connector, configured to be connected to a charging interface of the battery electric vehicle, so as to transfer power to the battery electric vehicle; and a first monitoring program. After pairing between charging station and the handheld electronic device succeeds, the first monitoring program randomly generates a charging authentication code and sends the charging authentication code to the handheld electronic device; during duration that the charging station charges the battery electric vehicle, the first monitoring program keeps monitoring whether the charging connector is separated from the charging interface, stops charging the battery electric vehicle when monitoring that the charging connector is separated from the charging interface, and transmits a charging confirmation request to the handheld electronic device; and after the first monitoring program of the charging station receives a charging continuation instruction transmitted by the handheld electronic device and the handheld electronic device transmits the charging authentication code to the charging station, the first monitoring program of the charging station continues charging the battery electric vehicle.

### BRIEF DESCRIPTION OF THE DRAWINGS

FIG. 1 is a schematic diagram of a preferred embodiment of a charging system of a battery electric vehicle according to the present invention;

FIG. 2 is a schematic flowchart of a preferred embodiment of a charging method of a battery electric vehicle according to the present invention; and

FIG. 3 is a schematic diagram of a preferred embodiment of a user interface displayed on a mobile phone of the charging system of a battery electric vehicle according to the present invention.

### DETAILED DESCRIPTION OF THE PREFERRED EMBODIMENTS

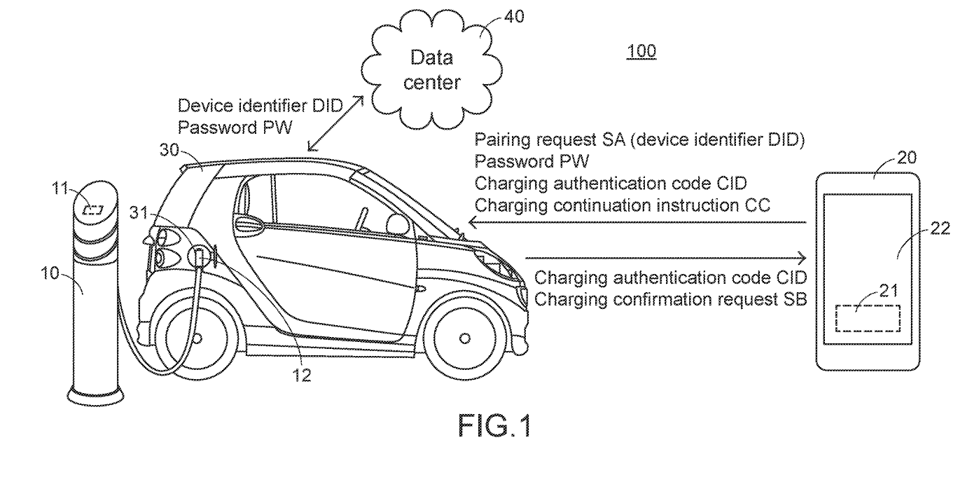

Referring to FIG. 1, FIG. 1 is a schematic diagram of a preferred embodiment of a charging system of a battery electric vehicle according to the present invention. FIG. 1 illustrates that the charging system 100 of the present invention includes: a charging station 10 and a handheld electronic device 20. The charging station 10 has a first monitoring program 11 and a charging connector 12. The handheld electronic device 20, using a mobile phone as an example herein, includes a second monitoring program 21. A battery electric vehicle 30 has a charging interface 31, configured to be connected to the charging connector 12, so as to receive power from the charging station 10.

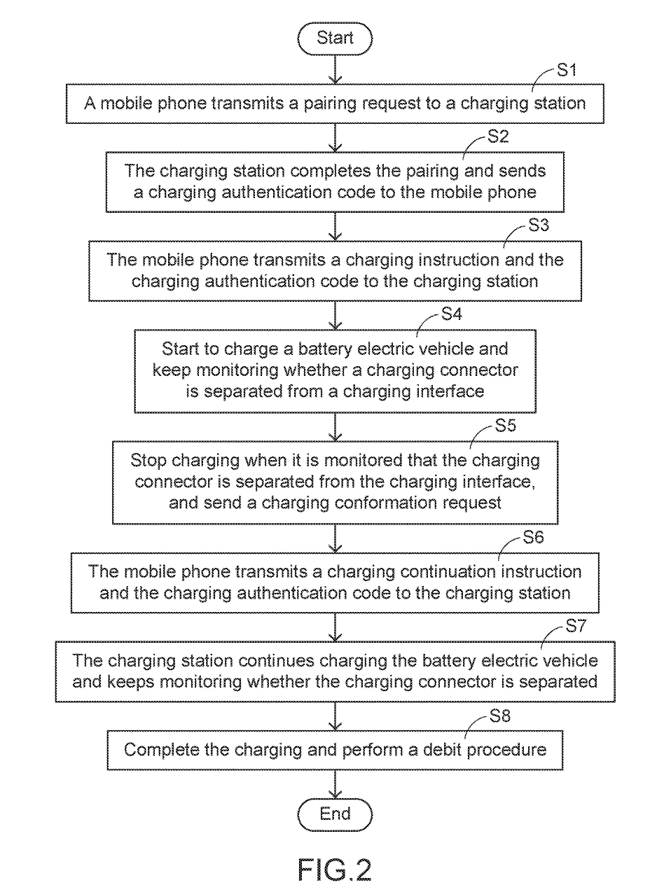

Referring to FIG. 2 in combination, FIG. 2 is a flowchart of a preferred embodiment of a charging method of the present invention. When a user of the battery electric vehicle 30 intends to charge the battery electric vehicle 30 by using the charging station 10, the user activates the second monitoring program 21 of the mobile phone 20, so as to send a pairing request SA to the charging station 10 (step S1). The pairing herein refers to pairing for establishing a short-range wireless connection between two electronic devices. For example, Bluetooth pairing may be used. During a pairing process, the user sends a device identifier DID of the mobile phone 20 to the charging station 10 by using the mobile phone 20. When confirming that the device identifier DID corresponds to a registered mobile phone, the first monitoring program 11 of the charging station 10 may determine that the pairing succeeds. After confirming that the pairing succeeds, the charging station 10 sends a charging authentication code CID to the mobile phone 20 (step S2). Specifically, in the system of the present invention, the user first logs on, by using the device identifier DID of the mobile phone that the user intends to use in the charging system, a data center 40 provided by a system provider that sets the charging station. For example, an IMEI (international mobile equipment identity) code of the mobile phone 20, and the IMEI code is regarded as the device identifier DID of the mobile phone. Certainly, the confirmation of the device identifier DID is implemented by transmitting, by the first monitoring program 11, the device identifier DID to the data center 40 for checking.

Then, the user transmits a charging start instruction to the charging station 10 by using the mobile phone 20. After receiving the charging start instruction transmitted by the mobile phone 20, the first monitoring program 11 of the charging station 10 requires the mobile phone 20 to transmit, to the charging station, the charging authentication code CID, and a password PW that is first logged on the data center 40 by the user. (Step S3) After confirming that the correct charging authentication code CID and password PW are received, the first monitoring program 11 starts to charge the battery electric vehicle 30. Certainly, each time when the charging station 10 intends to charge the battery electric vehicle 30, determining that the charging connector 12 is connected to the charging interface 31 needs to be performed before charging is performed. During charging, the first monitoring program 11 of the charging station 10 keeps monitoring whether the charging connector 12 is separated from the charging interface 31 (step S4).

When the first monitoring program 11 monitors that the charging connector 12 is separated from the charging interface 13 before the charging is completed, it indicates that the charging connector 13 may be used by a theft. Therefore, the first monitoring program 11 enables the charging station 10 to immediately stop charging the battery electric vehicle 30, and transmits a charging confirmation request SB to the mobile phone 20 (step S5), so as to notify the user of a possible electricity stealing situation. The user may decide, according to an actual condition, whether to continue charging. If the user does not find an abnormal situation, the user may transmit a charging continuation instruction CC to the charging station 10 by using the mobile phone 20. After receiving the charging continuation instruction CC, the charging station 10 requires the mobile phone 20 to retransmit the charging authentication code CID to the charging station 10 (step S6). After confirming that the charging authentication code CID is correct, the first monitoring program 11 charges the battery electric vehicle 30 again, and certainly, keeps monitoring whether the charging connector 12 is separated from the charging interface 31 (step S7).

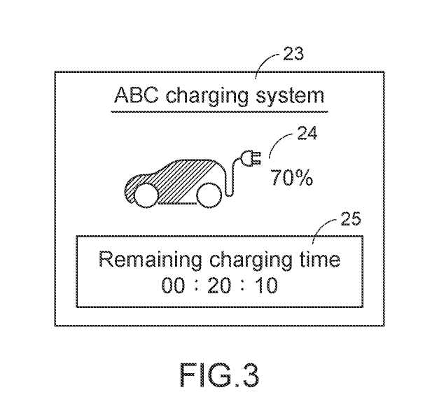

Referring to FIG. 3, which is a schematic diagram illustrating a preferred embodiment of a user interface 23 provided to the mobile phone 20 by the system according to the present invention. The second monitoring program 21 may provide a plurality of user interfaces, so that the user may receive/input instructions and data during the charging process. The user interface is displayed on a display screen 22 of the mobile phone 20. The user interface 23 in FIG. 3 provides information about a charging progress. For example, image 24 indicates a proportion of a charged quantity of electricity, and image 25 displays the remaining time for charging to 100%. Therefore, the user may acquire the current charging progress by using the mobile phone 20.

After the charging is completed, a debit procedure is subsequently performed, and if the user first logs on the data center 40 by using a debit account, the charging station 10 may directly debits money from the account (step S8).

It can be known from the foregoing description that the charging method of the present description enables a charging station and a mobile station to perform pairing. Therefore, no matter a user is near the charging station or not, the user may acquire a charging state by using the mobile phone. Besides, in the present invention, after the pairing is completed, the charging station transmits a charging authentication code to the mobile phone. The charging authentication code is randomly generated by the charging station. When a new pairing connection is established, the charging station generates another charging authentication code. In a case in which a charging connector is separated from a charging interface, the charging station may ensure, by requiring the mobile phone to transmit the charging authentication code, that a charging continuation request is an instruction delivered by the original user, so as to prevent an electricity stealing situation from occurring.

The foregoing descriptions are merely preferred embodiments of the present invention, but are not intended to limit the claims of the present invention. Therefore, equivalent variations or modifications without departing from the spirit of the present invention shall fall within the claims of the description.

What is claimed is:

1. A charging method of a battery electric vehicle, applied to charging, by using a charging station, a battery electric vehicle, wherein the charging station is connected to a charging interface of the battery electric vehicle by using a charging connector and transfers power to the battery electric vehicle, and the method comprises steps of:
(a) transmitting, by a handheld electronic device, a pairing request signal to the charging station;
(b) randomly generating, after the charging station receives the pairing request signal and confirms that pairing succeeds, a charging authentication code, and transmitting the charging authentication code to the handheld electronic device;
(c) transmitting, by the handheld electronic device, the charging authentication code to the charging station;
(d) starting to charge the battery electric vehicle when the charging station receives the charging authentication code and confirms that the charging connector is connected to the charging interface, wherein during duration that the battery electric vehicle is charged, the charging station keeps monitoring whether the charging connector is separated from the charging interface, stops charging the battery electric vehicle when monitoring that the charging connector is separated from the charging interface, and transmits a charging confirmation request to the handheld electronic device; and
(e) requiring, by the charging station, the handheld electronic device to provide the charging authentication code when the handheld electronic device transmits a charging continuation instruction to the charging station, and continuing charging the battery electric vehicle after receiving the charging authentication code.

2. The charging method of a battery electric vehicle according to claim 1, wherein after the charging station receives the pairing request signal, step (b) further comprises: requiring the handheld electronic device to provide a device identifier, and confirming, by the charging station, that the pairing succeeds when confirming that the device identifier is an identifier of a logged on device, wherein the device identifier is transmitted to an external data center by the charging station, and the data center confirms whether the device identifier is the identifier of the logged on device.

3. The charging method of a battery electric vehicle according to claim 2, wherein the device identifier is an IMEI (international mobile equipment identity) code of the handheld electronic device.

4. The charging method of a battery electric vehicle according to claim 1, wherein step (c) further comprises: transmitting, by the handheld electronic device, a password to the charging station; and step (d) further comprises: starting, by the charging station, to charge the battery electric when confirming that the password is a logged on password, wherein the password is transmitted to an external data center by the charging station, and the data center confirms whether the password is the logged on password.

5. The charging method of a battery electric vehicle according to claim 1, wherein after step (e), the method further comprises: step (f) confirming, after the charging station completes the charging, whether the handheld electronic device has a preset payment account, and executing a debit procedure on the preset payment account when the handheld electronic device has the preset payment account.

6. The charging method of a battery electric vehicle according to claim 1, wherein the handheld electronic device is a mobile phone.

7. A charging system of a battery electric vehicle, comprising:
a charging station, configured to provide power to a battery electric vehicle, wherein the charging station comprises:
a charging connector, configured to be connected to a charging interface of the battery electric vehicle, so as to transfer power to the battery electric vehicle; and
a first monitoring program; and
a handheld electronic device, comprising a second monitoring program, wherein after pairing between the charging station and the handheld electronic device succeeds, the first monitoring program randomly generates a charging authentication code and sends the charging authentication code to the handheld electronic device; during duration that the charging station charges the battery electric vehicle, the first monitoring program keeps monitoring whether the charging connector is separated from the charging interface, stops charging the battery electric vehicle when monitoring that the charging connector is separated from the charging interface, and transmits a charging confirmation request to the handheld electronic device; and after the first monitoring program of the charging station receives a charging continuation instruction transmitted by the handheld electronic device and the handheld electronic device transmits the charging authentication code to the charging station, the first monitoring program of the charging station continues charging the battery electric vehicle.

8. The charging system of a battery electric vehicle according to claim 7, wherein the second monitoring program further comprises providing a user interface that is displayed on a display screen of the handheld electronic device.

9. The charging system of a battery electric vehicle according to claim 7, wherein the user interface displays information about a current charged quantity of electricity and information about remaining charging time of the battery electric vehicle.

10. The charging system of a battery electric vehicle according to claim 7, wherein the handheld electronic device is a mobile phone.
